(19) United States
(12) Patent Application Publication
(10) Pub. No.: US 2016/0078814 A1
(43) Pub. Date: Mar. 17, 2016

(54) ORGANIC LIGHT EMITTING DISPLAY DEVICE

(71) Applicant: SAMSUNG DISPLAY CO., LTD., Yongin-City (KR)

(72) Inventors: Do-Hyung Ryu, Yongin-si (KR); Jae-Hoon Lee, Seoul (KR); Jae-Woo Song, Anyang-si (KR); Hae-Goo Jung, Seongnam-si (KR)

(21) Appl. No.: 14/660,893

(22) Filed: Mar. 17, 2015

(30) Foreign Application Priority Data
Sep. 16, 2014 (KR) 10-2014-0122484

(51) Int. Cl. G09G 3/32; H04N 13/04; G09G 3/20

(52) U.S. Cl. CPC G09G 3/3258; G09G 3/2003; H04N 13/04; G09G 2300/0871; G09G 2300/0426; G09G 2310/08; G09G 2320/0219

(57) ABSTRACT

An organic light emitting display device includes a display panel having pixels, a red color high power voltage line, a green color high power voltage line, a blue color high power voltage line, and a low power voltage line, a driving current calculator for calculating an amount of a red color driving current of image data, an amount of a green color driving current of the image data, and an amount of a blue color driving current of the image data, and a power supply for generating a red color high power voltage, a green color high power voltage, and a blue color high power voltage for which overshoot times are controlled to be within a falling time during which the low power voltage is changed from a first level to a second level or to be within a rising time during which the low power voltage is changed from the second level to the first level.

### CROSS-REFERENCE TO RELATED APPLICATION

This application claims priority to and the benefit of Korean Patent Application No. 10-2014-0122484, filed on Sep. 16, 2014 in the Korean Intellectual Property Office (KIPO), the content of which is incorporated herein in its entirety by reference.

### BACKGROUND

1. Field

Example embodiments of the present invention relate generally to a display device. For example, embodiments of the present invention relate to an organic light emitting display device.

2. Description of the Related Art

Flat panel display (FPD) devices are widely used in electronic devices because FPD devices are relatively lightweight and thin compared to cathode-ray tube (CRT) display device. Examples of FPD devices are liquid crystal display (LCD) devices, field emission display (FED) devices, plasma display panel (PDP) devices, and organic light emitting diode (OLED) display devices.

The OLED display devices are in the spotlight as next-generation display devices because the OLED display devices have various advantages such as a wide viewing angle, a rapid response speed, a small thickness, low power consumption, etc. The OLED display device includes scan lines, data lines, pixel circuits coupled to the scan lines and data lines, organic light emitting diodes respectively coupled to the pixel circuits, and power voltage lines that supply power voltages to the pixel circuits. As a resolution or a size of an OLED display device increases, the number of wires increases and thus a degree of integration increases. As the number of wires increases and thus the degree of integration increases, a possibility of image defects, caused by a coupling phenomenon, may increase.

### SUMMARY

Some example embodiments of the present invention provide an organic light emitting display device capable of improving image defects caused by a coupling phenomenon of power voltage lines.

According to an aspect of example embodiments, an organic light emitting display device may include a display panel including a plurality of pixels, a red color high power voltage line that provides a red color high power voltage to the pixels, a green color high power voltage line that provides a green color high power voltage to the pixels, a blue color high power voltage line that provides a blue color high power voltage to the pixels, and a low power voltage line that provides a low power voltage to the pixels, a driving current calculator configured to receive image data provided to the pixels and to respectively calculate an amount of a red color driving current of the image data, an amount of a green color driving current of the image data, and an amount of a blue color driving current of the image data, a power supply configured to generate the red color high power voltage, the green color high power voltage, and the blue color high power voltage for which overshoot times are controlled to be within a falling time during which the low power voltage is changed from a first level to a second level or to be within a rising time during which the low power voltage is changed from the second level to the first level, a data driver configured to provide a data signal to the pixels, a scan driver configured to provide a scan signal to the pixels, and a timing controller configured to control the power supply, the data driver, and the scan driver.

In example embodiments of the present invention, the red color high power voltage line, the green color high power voltage line, and the blue color high power voltage line may have a mesh structure.

In example embodiments of the present invention, the power supply may include a red color power voltage controller configured to calculate a degree of coupling of the red color high power voltage based on the amount of the red color driving current and to generate a red color power voltage control signal that controls the overshoot time of the red color high power voltage according to the degree of coupling of the red color high power voltage, a green color power voltage controller configured to calculate a degree of coupling of the green color high power voltage based on the amount of the green color driving current and to generate a green color power voltage control signal that controls the overshoot time of the green color high power voltage according to the degree of coupling of the green color high power voltage, a blue color power voltage controller configured to calculate a degree of coupling of the blue color high power voltage based on the amount of the blue color driving current and to generate a blue color power voltage control signal that controls the overshoot time of the blue color high power voltage according to the degree of coupling of the blue color high power voltage, a red color power voltage generator configured to generate the red color high power voltage based on the red color power voltage control signal, a green color power voltage generator configured to generate the green color high power voltage based on the green color power voltage control signal, a blue color power voltage generator configured to generate the blue color high power voltage based on the blue color power voltage control signal, and a low power voltage generator configured to generate the low power voltage.

In example embodiments of the present invention, each of the red color power voltage generator, the green color power voltage generator, and the blue color power voltage generator may include a first resistor and a second resistor configured to generate a divided voltage by dividing an output voltage provided to the display panel, a differential amplifier configured to output a difference between the divided voltage and a reference voltage, a third resistor and a first capacitor configured to control an output time of the differential amplifier, a comparator configured to compare an output of the differential amplifier with a sawtooth wave, and a half-bridge block configured to output a pulse width modulation (PWM) signal based on an output of the comparator.

In example embodiments of the present invention, third resistor may be implemented as a digital variable resistor.

In example embodiments of the present invention, a resistance of the third resistor may be changed based on the red color power voltage control signal, the green color power voltage control signal, and the blue color power voltage control signal, respectively.

In example embodiments of the present invention, the driving current calculator may include a red color driving current calculator configured to calculate the amount of the red color driving current of the image data, a green color driving current calculator configured to calculate the amount of the green color driving current of the image data, and a blue color driving current calculator configured to calculate the amount of the blue color driving current of the image data.

In example embodiments of the present invention, the driving current calculator may be included in the timing controller or is coupled to the timing controller.

In example embodiments of the present invention, the image data may include left-eye image data and right-eye image data when the organic light emitting display device operates as a 3D display device.

In example embodiments of the present invention, the low power voltage may have the first level during an address period in which the left-eye image data or the right-eye image data are written into the pixels, and the low power voltage may have the second level during an emission period in which the pixels emit light based on the left-eye image data or the right-eye image data.

According to an aspect of example embodiments of the present invention, an organic light emitting display device may include a display panel including a plurality of pixels, a red color high power voltage line that provides a red color high power voltage to the pixels, a green color high power voltage line that provides a green color high power voltage to the pixels, a blue color high power voltage line that provides a blue color high power voltage to the pixels, and a low power voltage line that provides a low power voltage to the pixels, a time measuring unit configured to measure a falling time during which the low power voltage is changed from a first level to a second level or a rising time during which the low power voltage is changed from the second level to the first level, a power supply configured to generate the red color high power voltage, the green color high power voltage, and the blue color high power voltage for which overshoot times are controlled to be within the falling time of the low power voltage or to be within the rising time of the low power voltage, a data driver configured to provide a data signal to the pixels, a scan driver configured to provide a scan signal to the pixels, and a timing controller configured to control the power supply, the data driver, and the scan driver.

In example embodiments of the present invention, the red color high power voltage line, the green color high power voltage line, and the blue color high power voltage line may have a mesh structure.

In example embodiments of the present invention, the power supply may include a red color power voltage controller configured to generate a red color power voltage control signal that controls the overshoot time of the red color high power voltage according to the falling time of the low power voltage or the rising time of the low power voltage, a green color power voltage controller configured to generate a green color power voltage control signal that controls the overshoot time of the green color high power voltage according to the falling time of the low power voltage or the rising time of the low power voltage, a blue color power voltage controller configured to generate a blue color power voltage control signal that controls the overshoot time of the blue color high power voltage according to the falling time of the low power voltage or the rising time of the low power voltage, a red color power voltage generator configured to generate the red color high power voltage based on the red color power voltage control signal, a green color power voltage generator configured to generate the green color high power voltage based on the green color power voltage control signal, a blue color power voltage generator configured to generate the blue color high power voltage based on the blue color power voltage control signal, and a low power voltage generator configured to generate the low power voltage.

In example embodiments of the present invention, each of the red color power voltage generator, the green color power voltage generator, and the blue color power voltage generator may include a first resistor and a second resistor configured to generate a divided voltage by dividing an output voltage provided to the display panel, a differential amplifier configured to output a difference between the divided voltage and a reference voltage, a third resistor and a first capacitor configured to control an output time of the differential amplifier, a comparator configured to compare an output of the differential amplifier with a sawtooth wave, and a half-bridge block configured to output a pulse width modulation (PWM) signal based on the output of the comparator.

In example embodiments of the present invention, the third resistor may be implemented as a digital variable resistor.

In example embodiments of the present invention, a resistance of the third resistor may be changed based on the red color power voltage control signal; the green color power voltage control signal, and the blue color power voltage control signal, respectively.

In example embodiments of the present invention, the time measuring unit may include a clock generator configured to generate a reference clock having a cycle, and the time measuring unit may count the reference clock during the falling time of the low power voltage or during the rising time of the low power voltage, and calculate the falling time of the low power voltage or the rising time of the low power voltage based on the counted reference clock.

In example embodiments of the present invention, the time measuring unit may measure the falling time of the low power voltage or the rising time of the low power voltage using a timer.

In example embodiments of the present invention, image data may be provided to the pixels and the image data may include left-eye image data and right-eye image data when the organic light emitting display device operates as a 3D display device.

In example embodiments of the present invention, the low power voltage may have the first level during an address period in which the left-eye image data or the right-eye image data are written into the pixels, and the low power voltage may have the second level during an emission period in which the pixels emit light based on the left-eye image data or the right-eye image data.

Therefore, an organic light emitting display device according to example embodiments of the present invention may improve image defects by controlling an overshoot time of a high power voltage when a level of a low power voltage is changed.

### BRIEF DESCRIPTION OF THE DRAWINGS

Illustrative, non-limiting example embodiments of the present invention will be more clearly understood from the following detailed description taken in conjunction with the accompanying drawings.

FIG. 1 is a block diagram illustrating an organic light emitting display device according to example embodiments of the present invention.

FIG. 2 is a circuit diagram illustrating an example of a pixel included in the organic light emitting display device of FIG. 1.

FIG. 3 is a diagram illustrating an example of a high power voltage lines included in the organic light emitting display device of FIG. 1.

FIG. 4 is a waveform diagram for describing an example of a high power voltage generated by the organic light emitting display device of FIG. 1.

FIG. 5 is a block diagram illustrating a driving current calculator and a power supply included in the organic light emitting display device of FIG. 1.

FIG. 6 is a circuit diagram illustrating a voltage generator included in the power supply of FIG. 5.

FIG. 7 is a waveform diagram illustrating an example of the organic light emitting display device of FIG. 1 that is implemented as a 3D display device.

FIG. 8 is a block diagram illustrating an organic light emitting display device according to example embodiments of the present invention.

FIGS. 9A and 9B are waveform diagrams for describing a time measuring unit included in the organic light emitting display device of FIG. 8.

FIG. 10 is a block diagram illustrating a time measuring unit and a power supply included in the organic light emitting display device of FIG. 8.

FIG. 11 is a waveform diagram illustrating an example of the organic light emitting display device of FIG. 8 that is implemented as a 3D display device.

### DETAILED DESCRIPTION

Hereinafter, embodiments of the present invention will be explained in detail with reference to the accompanying drawings.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

It will be understood that when an element or layer is referred to as being “on”, “connected to”, “coupled to”, or “adjacent to” another element or layer, it can be directly on, connected to, coupled to, or adjacent to the other element or layer, or one or more intervening elements or layers may be present. When an element or layer is referred to as being “directly on,” “directly connected to”, “directly coupled to”, or “immediately adjacent to” another element or layer, there are no intervening elements or layers present.

As used herein, the term “substantially,” “about,” and similar terms are used as terms of approximation and not as terms of degree, and are intended to account for the inherent deviations in measured or calculated values that would be recognized by those of ordinary skill in the art.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

Further, the use of “may” when describing embodiments of the inventive concept refers to “one or more embodiments of the inventive concept.”

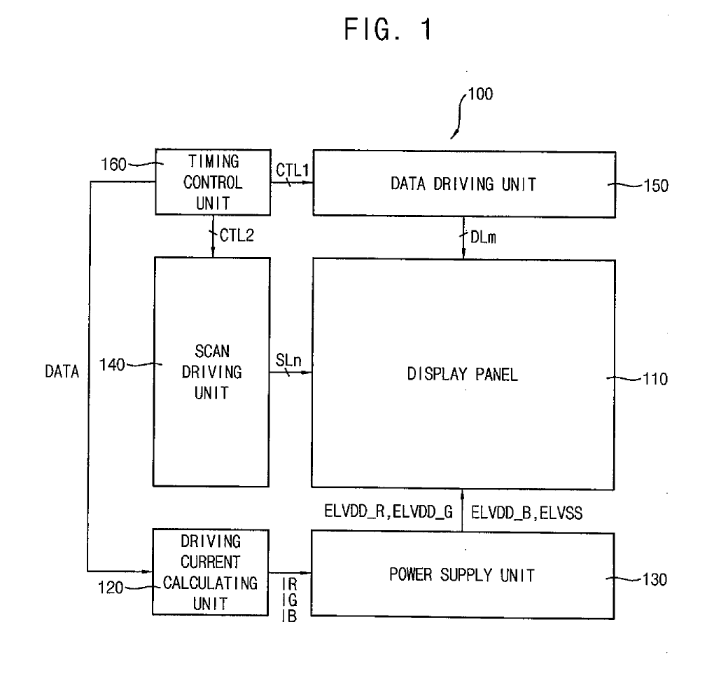

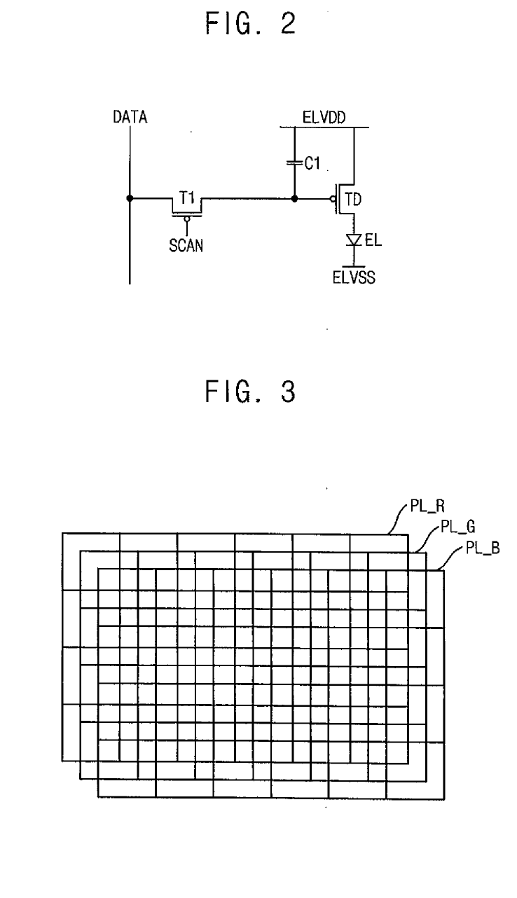

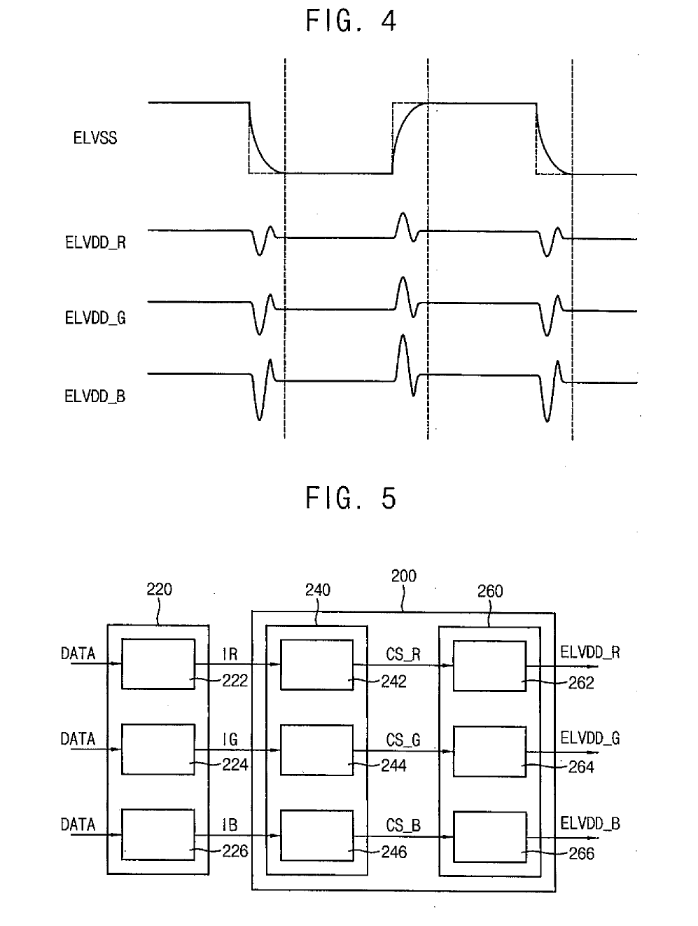

FIG. 1 is a block diagram illustrating an organic light emitting display device according to example embodiments of the present invention. FIG. 2 is a circuit diagram illustrating an example of a pixel included in the organic light emitting display device of FIG. 1. FIG. 3 is a diagram illustrating an example of a high power voltage line included in the organic light emitting display device of FIG. 1. FIG. 4 is a waveform diagram for describing an example of a high power voltage generated by the organic light emitting display device of FIG. 1.

Referring to FIG. 1, the organic light emitting display device 100 may include a display panel 110, a driving current calculating unit 120 (e.g., a driving current calculator 120), a power supply unit 130 (e.g., a power supply 130), a scan driving unit 140 (e.g., a scan driver 140), a data driving unit 150 (e.g., a data driver 150), and a timing control unit 160 (e.g., a timing controller 160).

A plurality of pixels may be formed on the display panel 110. The plurality of pixels may be disposed at crossing regions of a plurality of data lines DLm and a plurality of scan lines SLn. Each of the pixels (or subpixels) may include a red color sub pixel, a green color sub pixel, and a blue color sub pixel. Here, each of pixels may include an organic light emitting diode. Referring to FIG. 2, each of the pixels may include a pixel circuit having a switching transistor T1 and a storage capacitor C1, a driving transistor TD, and an organic light emitting diode EL. In this case, the pixel circuit may operate to provide a data signal, where the data signal is provided via data-lines DLm, to the driving transistor based on a scan signal, where the scan signal is provided via scan-lines SLn. The driving transistor TD may control a current flowing through the organic light emitting diode EL based on the data signal, and the organic light emitting diode EL may emit light based on the current.

Referring to FIG. 2 and FIG. 3, a red color high power voltage line PL_R that provides a red color high power voltage ELVDD_R to the pixels, a green color high power voltage line PL_G that provides a green color high power voltage ELVDD_G to the pixels, a blue color high power voltage line PL_B that provides a blue color high power voltage ELVDD_B to the pixels, and a low power voltage line that provides a low power voltage ELVSS to the pixels may be formed on the display panel 110.

The red color high power voltage ELVDD_R may be a high power voltage provided to the red color sub pixels that emit red light. The red color high power voltage ELVDD_R may be provided to the pixels through the red color high power voltage line PL_R.

The green color high power voltage ELVDD_G may be a high power voltage provided to the green color sub pixels that emit green light. The green color high power voltage ELVDD_G may be provided to the pixels through the green color high power voltage line PL_G.

The blue color high power voltage ELVDD_B may be a high power voltage provided to the blue color sub pixels that emit blue light. The blue color high power voltage ELVDD_B may be provided to the pixels through the blue color high power voltage ling PL_B.

As illustrate in FIG. 3, the red color high power voltage line PL_R, the green high power voltage line PL_G, and the blue high power voltage line PL_B may be formed in a mesh structure. The low power voltage line that provides low power voltage ELVSS may be formed in a face structure (e.g., a planar structure) above or under the red color high power voltage line PL_R, the green color high power voltage line PL_G, and the blue color high power voltage line PL_B. The low power voltage line may provide the low power voltage ELVSS to the red color sub pixel, the green color sub pixel, and the blue color sub pixel.

A voltage level of the low power voltage ELVSS may be switched in a cycle (e.g., a predetermined cycle) and be provided to the pixels according to a method of driving the organic light emitting display device 100. In some example embodiments of the present invention, the organic light emitting display device 100 may write data into the pixels while the low power voltage ELVSS has a first level, and may emit pixels while the low power voltage ELVSS has a second level.

In other example embodiments of the present invention, the organic light emitting display device 100 may write data into the pixels while the low power voltage ELVSS has the second level, and may emit pixels while the low power voltage ELVSS has the first level. When a voltage level of the low power voltage ELVSS is changed, a parasitic capacitor may be formed between the low power voltage line and each of the red color high power voltage line PL_R, the green color high power voltage lien PL_G, and the blue color high power voltage line PL_B. A coupling phenomenon may be caused by the parasitic capacitor. Here, a degree of coupling of the red color high power voltage ELVDD_R, a degree of coupling of the green color high power voltage ELVDD_G, and a degree of coupling of the blue color high power voltage ELVDD_B may be different from each other. Thus, a color abnormality defect may occur.

For example, when a white color image is displayed on the display panel 110, an amount of a blue color driving current flowing through the blue color sub pixel is larger than an amount of a red color driving current and an amount of a green color driving current. Thus, the degree of coupling of the blue color high power voltage ELVDD_B is bigger than the degree of coupling of the red color high power voltage ELVDD_R and the degree of coupling of the green color high power voltage ELVDD_G. In this case, some lines of the display panel 110 may be displayed in yellow color because the amount of the blue driving current decreases.

To overcome these problems, the organic light emitting display device 100 according to example embodiments of the present invention may control overshoot times of the red color high power voltage ELVDD_R, the green color high power voltage ELVDD_G, and the blue color high power voltage ELVDD_B to be within a falling time of the low power voltage or to be within the rising time of the low power voltage. Hereinafter, the organic light emitting display device of FIG. 1 will be described in detail.

Referring to FIG. 1, the driving current calculator 120 may receive image data DATA provided to the pixels and may respectively calculate the amount of the red color driving current IR of the image data DATA, the amount of the green color driving current IG of the image data DATA, and the amount of the blue color driving current IB of the image data DATA. The amount of the red driving current IR may be an amount of a driving current that will flow through the red color sub pixel based upon the image data DATA, the amount of the green color driving current IG may be an amount of a driving current that will flow through the green color sub pixel based upon the image data DATA, and the amount of the blue driving current IB may be an amount of a driving current that will flow through the blue color sub pixel based upon the image data DATA.

For example, the amount of the red color driving current IR, the amount of the green color driving current IG, and the amount of the blue color driving current IB may be calculated based on a gray level value (e.g., a grayscale value) of the image data DATA. The driving current calculator 120 may provide the amount of the red color driving current IR, the amount of the green color driving current IG, and the amount of the blue color driving current IB to the power supply 130. In some example embodiments of the present invention, the driving current calculator 120 may be included in the timing controller 160. In other example embodiments of the present invention, the driving current calculator 120 may be coupled to the timing controller 160.

The power supply 130 may generate the red color high power voltage ELVDD_R, the green color high power voltage ELVDD_G, and the blue color high power voltage ELVDD_B for which overshoot times are controlled to be within the falling time during which the low power voltage is changed from the first level to the second level or to be within the rising time during which the low power voltage ELVSS is changed from the second level to the first level. Referring to FIG. 4, the overshoot times of the red color high power voltage ELVDD_R, the green color high power voltage ELVDD_G, and the blue color high power voltage ELVDD_B may be controlled to be within the falling time of the low power voltage ELVSS or rising time of the low power voltage ELVSS.

In some example embodiments of the present invention, when the pixels emit light while the low power voltage ELVSS has the second level, the power supply 130 may control the overshoot times of the red color high power voltage ELVDD_R, the green color high power voltage ELVDD_G, and the blue color high power voltage ELVDD_B to be within the falling time during which the low power voltage ELVSS is changed from the first level to the second level. Thus, the color abnormality defect caused by a difference in the degree of coupling of the red color high power voltage ELVDD_R, the degree of coupling of the green color high power voltage ELVDD_G, and the degree of coupling of the blue color high power voltage ELVDD_B may be improved.

In other example embodiments of the present invention, when the pixels emit light while the low power voltage ELVSS has the first level, the power supply 130 may control the overshoot times of the red color high power voltage ELVDD_R, the green color high power voltage ELVDD_G, and the blue color high power voltage ELVDD_B to be within the rising time during which the low power voltage ELVSS is changed from the second level to the first level. Thus, the color abnormality defect caused by a difference in the degree of coupling of the red color high power voltage ELVDD_R, the degree of coupling of the green color high power voltage ELVDD_G, and the degree of coupling of the blue color high power voltage ELVDD_B may be improved.

The power supply 130 may calculate the degree of coupling of the red color high power voltage ELVDD_R and may generate the red color high power voltage ELVDD_R for which overshoot time is controlled according to the degree of coupling of the red color high power voltage ELVDD_R. The power supply 130 may calculate the degree of coupling of the green color high power voltage ELVDD_G and may generate the green color high power voltage ELVDD G for which overshoot time is controlled according to the degree of coupling of the green color high power voltage ELVDD_G. The power supply 130 may calculate the degree of coupling of the blue color high power voltage ELVDD_B and may generate the blue color power voltage ELVDD B for which overshoot time is controlled according to the degree of coupling of the blue color high power voltage ELVDD_B.

The scan driver 140 may provide a scan signal to the pixels via the plurality of scan lines SLn. The data driver 150 may provide a data signal to the pixels via the plurality of data lines DLm according to the scan signal. The timing controller 160 may control the scan driver 140, the data driver 150, and the power supply 130 by generating a plurality of control signals CTL1 and CTL2.

As described above, the organic light emitting display device 100 according to example embodiments of the present invention may calculate the amount of the red color driving current IR, the amount of the green color driving current IG, and the amount of the blue color driving current IB of the image data DATA and may calculate the degrees of coupling of the red color high power voltage ELVDD_R, the green color high power voltage ELVDD_G, and the blue color high power voltage ELVDD_B according to the amount of the red color driving current IR, the amount of the green color driving current IG, and the amount of the blue color driving current IB. The organic light emitting display device 100 may prevent or reduce the color abnormality defects by controlling the overshoot times of the red color driving current IR, the amount of the green color driving current IG, and the amount of the blue color driving current IB to be within the falling time of the low power voltage ELVSS or the rising time of the low power voltage ELVSS.

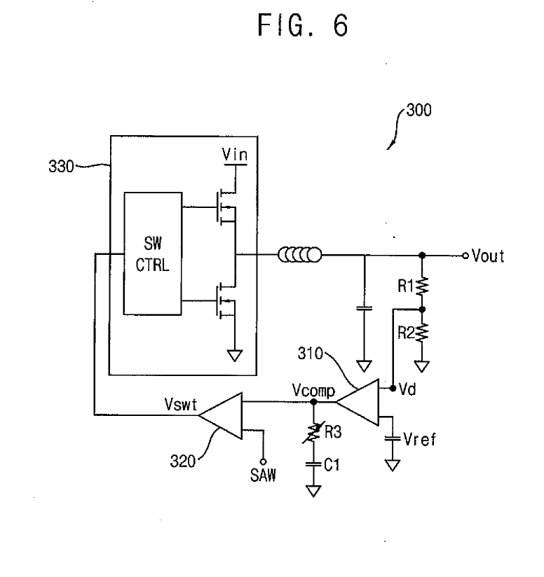

FIG. 5 is a block diagram illustrating a driving current calculator and a power supply included in the organic light emitting display device of FIG. 1. FIG. 6 is a circuit diagram illustrating a voltage generator included in the power supply of FIG. 5. The driving current calculator 220 of FIG. 5 may correspond to the driving current calculator 120 of FIG. 1, and the power supply 200 of FIG. 5 may correspond to the power supply 130 of FIG. 1.

Referring to FIG. 5, the driving current calculator 220 may include a red color driving current calculator 222, a green color driving current calculator 224, and a blue color driving current calculator 226. The red color driving current calculator 222 may store image data DATA of each frame and may calculate an amount of a red color driving current IR of the image data DATA. The amount of the red color driving current IR may be an amount of a driving current that will flow through a red color sub pixel based on the image data DATA. For example, the amount of the red color driving current IR may be calculated based on a gray level value (e.g., a grayscale value) of the image data DATA.

The green color driving current calculator 224 may store the image data DATA of each frame and may calculate an amount of a green color driving current IG of the image data DATA. The amount of the green color driving current IG may be an amount of a driving current that will flow through a green color sub pixel based on the image data DATA. For example, the amount of the green color driving current IG may be calculated based on the gray level (e.g., the grayscale) of the image data DATA.

The blue color driving current calculator 226 may store the image data DATA of each frame and may calculate an amount of a blue color driving current IB of the image data DATA. The amount of the blue color driving current IB may be an amount of a driving current that will flow through a blue color sub pixel based on the image data DATA. For example, the amount of the blue color driving current IB may be calculated based on the gray level value (e.g., the grayscale value) of the image data DATA.

The power supply 200 may include a power voltage controller 240 and a power voltage generator 260.

The power voltage controller 240 may include a red color power voltage controller 242, a green color power voltage controller 244, and a blue color power voltage controller 246. The red color power voltage controller 242 may calculate a degree of coupling of the red color high power voltage ELVDD_R based on the amount of the red color driving current IR and may generate a red color power voltage control signal CS_R that controls an overshoot time of the red color high power voltage ELVDD_R according to the degree of coupling of the red color high power voltage ELVDD_R. The degree of coupling of the red color high power voltage ELVDD_R may be changed according to a property of a parasitic capacitor formed by the red color high power voltage line PL_R and the low power voltage line, and the amounts of the red color driving current IR.

Here, the property of the parasitic capacitor may be determined by a material of the red color high power voltage line PL_R, a material of the low power voltage line, and a material that is between the red color high power voltage line PL_R and the low power voltage line. The red color power voltage controller 242 may include a lookup table (LUT) that stores the red color power voltage control signal CS_R corresponding to the degree of coupling of the red color high power voltage ELVDD_R. The red color power voltage control signal CS_R may control the overshoot time of the red color high power voltage ELVDD_R according to the degree of coupling of the red color high power voltage ELVDD_R. It should be understood that the lookup table can be implemented by any storage device capable of storing the red color power voltage control signal CS_R corresponding to the degree of coupling of the red color high power voltage ELVDD_R.

The green color power voltage controller 244 may calculate a degree of coupling of the green color high power voltage ELVDD_G based on the amount of the green color driving current IG and may generate a green color power voltage control signal CS_G that controls an overshoot time of the green color high power voltage ELVDD_G according to the degree of coupling of the green color high power voltage ELVDD_G. The degree of coupling of the green color high power voltage ELVDD_G may be changed according to a property of a parasitic capacitor formed by the green color high power voltage line PL_G and the low power voltage line, and the amounts of the green color driving current IG.

Here, the property of the parasitic capacitor may be determined by a material of the green color high power voltage line PL_G, a material of the low power voltage line, and a material that is between the green color high power voltage line PL_G and the low power voltage line. The green color power voltage controller 244 may include a lookup table that stores the green color power voltage control signal CS_G corresponding to the degree of coupling of the green color high power voltage ELVDD_G. The green color power voltage control signal CS_G may control the overshoot time of the green color high power voltage ELVDD_G. It should be understood that the lookup table can be implemented by any storage device capable of storing the green color power voltage control signal CS_G corresponding to the degree of coupling of the green color high power voltage ELVDD_G.

The blue color power voltage controller 246 may calculate a degree of coupling of the blue color high power voltage ELVDD_B based on the amount of the blue color driving current IB and may generate a blue color power voltage control signal CS_B that controls an overshoot time of the blue color high power voltage ELVDD_B according to the degree of coupling of the blue color high power voltage ELVDD_B. The degree of coupling of the blue color high power voltage ELVDD_B may be changed according to a property of a parasitic capacitor formed by the blue color high power voltage line PL_B and the low power voltage line, and the amounts of the blue color driving current IB.

Here, the property of the parasitic capacitor may be determined by a material of the blue color high power voltage line PL_B, a material of the low power voltage line, and a material that is between the blue color high power voltage line PL_B and the low power voltage line. The blue color power voltage controller 246 may include a lookup table that stores the blue color power voltage control signal CS_B corresponding to the degree of coupling of the blue color high power voltage ELVDD_B. The blue color power voltage control signal CS_B may control the overshoot time of the blue color high power voltage ELVDD_B. It should be understood that the lookup table can be implemented by any storage device capable of storing the blue color power voltage control signal CS_B corresponding to the degree of coupling of the blue color high power voltage ELVDD_B.

The power voltage generator 260 may include a red color power voltage generator 262, a green color power voltage generator 264, and a blue color power voltage generator 266. Referring to FIG. 6, each of the red color power voltage generator 262, the green color power voltage generator 264, and the blue color power voltage generator 266 may include a first resistor R1, a second resistor R2, a third resistor R3, a first capacitor C1, a differential amplifier 310, a comparator 320, and a half-bridge block 330. The first resistor R1 and the second resistor R2 may generate a divided voltage Vd by dividing an output voltage Vout provided to the display panel. The first resistor R1 may be coupled to the second resistor R2 in series. The divided voltage Vd may be applied to an input terminal of the differential amplifier 310. The differential amplifier 310 may output a difference between the divided voltage Vd and a reference voltage Vref (e.g., a predetermined reference voltage Vref). An output Vcomp of the differential amplifier 310 may be applied to an input terminal of the comparator 320. Here, the third resistor R3 and the first capacitor C1 may control an output timing of the differential amplifier 310. That is, the third resistor R3 and the first capacitor C1 may be operated to provide an RC time constant that controls the output timing of the differential amplifier 310. The third resistor R3 may be implemented as a digital variable resistor. A resistance of the third resistor R3 may be changed by the red color power voltage control signal CS_R or the green color power voltage control signal CS_G or the blue color power voltage control signal CS_B that is applied from the power voltage controller 240.

The comparator 320 may compare the output Vcomp of the differential amplifier 310 with a sawtooth wave SAW (e.g., a predetermined sawtooth wave SAW). In some example embodiments of the present invention, the comparator 320 may output a logic high signal when the output Vcomp of the differential amplifier 310 is lower than the sawtooth wave SAW, and the comparator 320 may output a logic low signal when the output Vcomp of the differential amplifier 310 is higher than the sawtooth wave SAW. In other example embodiments of the present invention, the comparator 320 may output a logic low signal when the output Vcomp of the differential amplifier 310 is lower than the sawtooth wave SAW, and the comparator 320 may output a logic high signal when the output Vcomp of the differential amplifier 310 is higher than the sawtooth wave SAW. An output Vswt of the comparator 320 may be applied to the half-bridge block 330. The half-bridge block 330 may output pulse width modulation (PWM) signal based on the output Vswt of the comparator 320. The half-bridge block 330 may selectively output an input voltage Vin and a ground voltage GND according to the output Vswt of the comparator 320 using a switch control block SW CTRL.

The red color power voltage generator 262 may generate the red color high power voltage ELVDD_R based on the red color power voltage control signal CS_R. The red color power voltage generator 262 may correspond to the power voltage generator 300 of FIG. 6. The red color power voltage generator 262 may change the resistance of the third resistor R3 based on the red color power voltage control signal CS_R. The red color power voltage generator 262 may generate the red color high power voltage ELVDD_R for which the overshoot time is controlled according to the resistance of the third resistor R3.

The green color power voltage generator 264 may generate the green color high power voltage ELVDD_G based on the green color power voltage control signal CS_G. The green color power voltage generator 264 may correspond to the power voltage generator 300 of FIG. 6. The green color power voltage generator 264 may change the resistance of the third resistor R3 based on the green color power voltage control signal CS_G. The green color power voltage generator 264 may generate the green color high power voltage ELVDD_G for which the overshoot time is controlled according to the resistance of the third resistor R3.

The blue color power voltage generator 266 may generate the blue color high power voltage ELVDD_B based on the blue color power voltage control signal CS_B. The blue color power voltage generator 266 may correspond to the power voltage generator 300 of FIG. 6. The blue color power voltage generator 266 may change the resistance of the third resistor R3 based on the blue color power voltage control signal CS_B. The blue color power voltage generator 266 may generate the blue color high power voltage ELVDD_B for which the overshoot time is controlled according to the resistance of the third resistor R3.

As described above, the driving current calculator 220 and the power supply 200 according to example embodiments of the present invention may control the overshoot times of the red color high power voltage ELVDD_R, the green color high power voltage ELVDD_G, and the blue color high power voltage ELVDD_B to be within the falling time of the low power voltage ELVSS or the rising time of the low power voltage ELVSS according to the degree of coupling of the red color high power voltage ELVDD_R, the degree of coupling of the green color high power voltage ELVDD_G, and the degree of coupling of the blue color high power voltage ELVDD_B. Thus, the color abnormality defect caused by a difference in the degree of coupling of the red color high power voltage ELVDD_R, the degree of coupling of the green color high power voltage ELVDD_G, and the degree of coupling of the blue color high power voltage ELVDD_B may be improved.

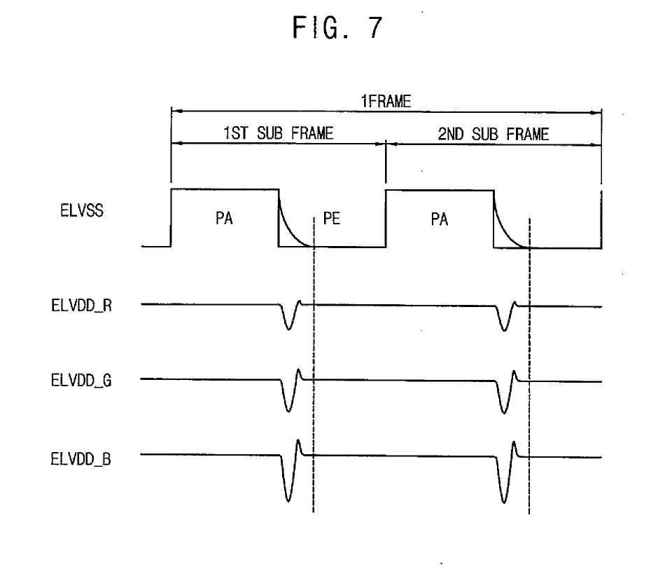

FIG. 7 is a waveform diagram illustrating an example of the organic light emitting display device of FIG. 1 that is implemented as a 3D display device.

Referring to FIG. 7, when an organic light emitting display device operates as a 3D display device, left-eye image data and right-eye image data may be alternately provided to a display panel. One frame may include a first sub frame and a second sub frame. The left-eye image data may be provided to the display panel during the first sub frame, and the right-eye image data may be provided to the display panel during the second sub frame. The driving current calculator may store the left-eye image data and the right-eye image data of each frame. The driving current calculator may provide an amount (e.g., magnitude value) of the red color driving current IR of the left-eye image data, an amount of the green color driving current IG of the left-eye image data, and an amount of the blue color driving current IB of the left-eye image data. Further, the driving current calculator may provide the amount of the red color driving current IR of the right-eye image data, the amount of the green color driving current IG of the right-eye image data, and the amount of the blue color driving current IB of the right-eye image data.

The first sub frame may include an address period PA in which the left-eye image data is written into pixels and an emission period PE in which the pixels emit light based on the left-eye image data. The low power voltage ELVSS may have the first level in the address period PA of the first sub frame, and may have the second level in the emission period PE of the first sub frame. The power supply may generate the red color high power voltage ELVDD_R, the green color high power voltage ELVDD_G, and the blue color high power voltage ELVDD_B of the first sub frame for which overshoot times are controlled to be within the falling time of the low power voltage ELVSS based on the amount of the red color driving current of the left-eye image data, the amount of the green color driving current of the left-eye image data, and the amount of the blue color driving current of the left-eye image data.

Further, the second sub frame may include an address period PA in which the right-eye image data is written into the pixels and an emission period PE in which the pixels emit light based on the right-eye image data. The low power voltage ELVSS may have the first level in the address period PA of the second sub frame, and may have the second level in the emission period PE of the second sub frame. The power supply may generate the red color high power voltage ELVDD_R, the green color high power voltage ELVDD_G, and the blue color high power voltage ELVDD_B of the second sub frame for which overshoot times are controlled to be within the falling time of the low power voltage ELVSS based on the amounts of the red color driving current of the right-eye image data, the amounts of the green color driving current of the right-eye image data, and the blue color driving current of the right-eye image data. Thus, the color abnormality defect caused by a difference in a degree of coupling of the red color high power voltage ELVDD_R, a degree of coupling of the green color high power voltage ELVDD_G, and a degree of coupling of the blue color high power voltage ELVDD_B may be improved when the organic light emitting display device operates as the 3D display device.

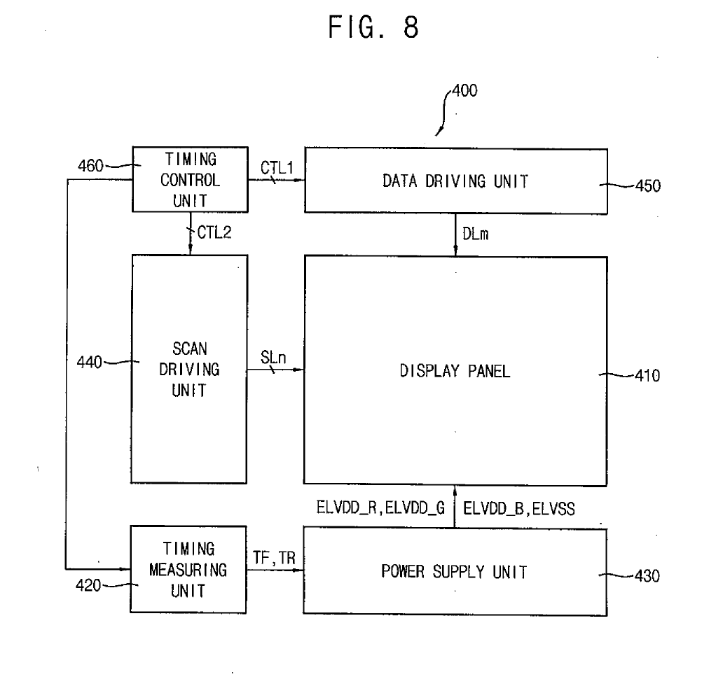

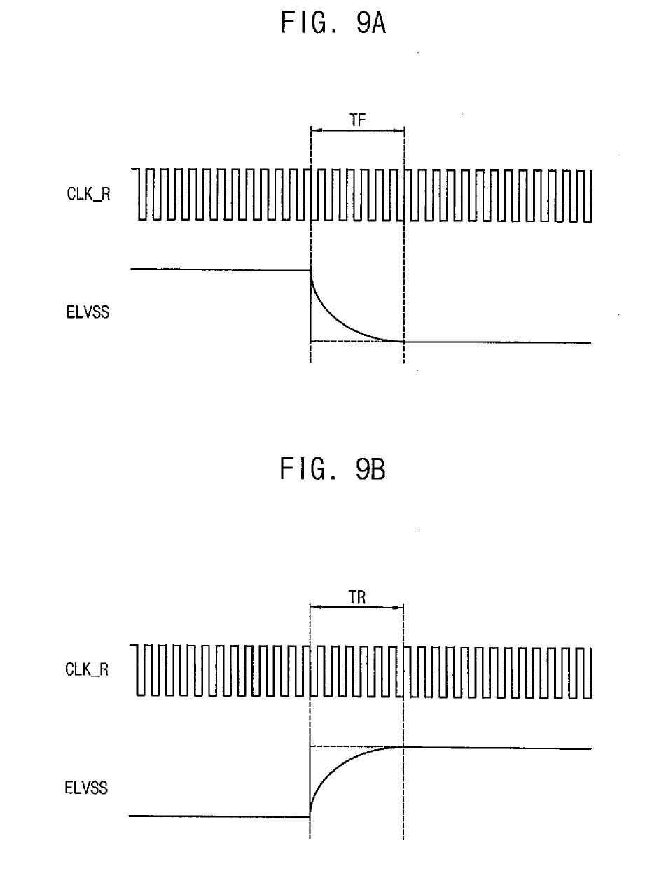

FIG. 8 is a block diagram illustrating an organic light emitting display device according to example embodiments of the present invention. FIGS. 9A and 9B are waveform diagrams for describing a time measuring unit included in the organic light emitting display device of FIG. 8.

Referring to FIG. 8, the organic light emitting display device 400 may include a display panel 410, a time measuring unit 420, a power supply unit 430 (e.g., a power supply 430), a scan driving unit 440 (e.g., a scan driver 440), a data driving unit 450 (e.g., a data driver 450), and a timing control unit 460 (e.g., a timing controller) 460.

A plurality of pixels may be formed on the display panel 510. The plurality of pixels may be disposed at crossing regions of a plurality of data lines DLm and a plurality of scan lines SLn. Each of the pixels may include a red color sub pixel, a green color sub pixel, and a blue color sub pixel. A red color high power voltage line PL_R that provides a red color high power voltage ELVDD_R to the pixels, a green color high power voltage line PL_G that provides a green color high power voltage ELVDD_G to the pixels, a blue color high power voltage line PL_B that provides a blue color high power voltage ELVDD_B to the pixels, and a low power voltage line that provides a low power voltage ELVSS to the pixels may be formed on the display panel.

The red color high power voltage ELVDD_R may be a high power voltage provided to the red color sub pixels that emit red color light. The red color high power voltage ELVDD_R may be provided to the pixels through the red color high power voltage line PL_R.

The green color high power voltage ELVDD_G may be a high power voltage provided to the green color sub pixels that emit green color light. The green color high power voltage ELVDD_G may be provided to the pixels through the green color high power voltage line PL_G.

The blue color high power voltage ELVDD_B may be high power voltage provided to the blue color sub pixels that emit blue color light. The blue color high power voltage ELVDD_B may be provided to the pixels through the blue color high power voltage ling PL_B.

As illustrate in FIG. 3, the red color high power voltage line PL_R, the green color high power voltage line PL_G, and the blue color high power voltage line PL_B may be formed in a mesh structure. The low power voltage line that provides low power voltage ELVSS may be formed in a face structure above or under the red color high power voltage line PL_R, the green color high power voltage line PL_G, and the blue color high power voltage line PL_B. The low power voltage line may provide the low power voltage ELVSS to the red color sub pixel, the green color sub pixel, and the blue color sub pixel.

When a voltage level of the low power voltage ELVSS is changed, a parasitic capacitor may be formed between the low power voltage line and each of the red color high power voltage line PL_R, the green color high power voltage lien PL_G, and the blue color high power voltage line PL_B. A coupling phenomenon may be caused by the parasitic capacitor. Here, a degree of coupling of the red color high power voltage ELVDD_R, a degree of coupling of the green color high power voltage ELVDD_G, and a degree of coupling of the blue color high power voltage ELVDD_B may be different from each other. Thus, a color abnormality defect may occur.

The time measuring unit 420 may measure a falling time TF during which the low power voltage ELVSS is changed from a first level to a second level or a rising time TR during which the low power voltage ELVSS is changed from the second level to the first level. A voltage level of the low power voltage ELVSS may be switched in a cycle (e.g., a predetermined cycle) and be provided to the pixels according to a method of driving the organic light emitting display device 510.

In some example embodiments of the present invention, the organic light emitting display device 500 may write data into the pixels while the low power voltage ELVSS has a first level, and may emit pixels while the low power voltage ELVSS has a second level. In other example embodiments of the present invention, the organic light emitting display device 500 may write data into the pixels while the low power voltage ELVSS has the second level, and may emit pixels while the low power voltage ELVSS has the first level. In some example embodiments of the present invention, the time measuring unit 420 may include a clock generator that generates a reference clock CLK_R having a cycle (e.g., a predetermined cycle). The time measuring unit 420 may count the reference clock during the falling time TF of the low power voltage ELVSS or the rising time TR of the low power voltage ELVSS and may calculate the falling time TF or the rising time TR based on the counted reference clock CLK_R.

As illustrated in FIGS. 9A and 9B, the clock generator may generate the reference clock CLK_R having substantially the same width (e.g., having the same width) of each cycle. The time measuring unit 420 may calculate the falling time TF of the low power voltage ELVSS or the rising time TR of the low power voltage ELVSS based on the number of the reference clock CLK_R cycles output during the falling time TF of the low power voltage ELVSS or the rising time TR of the low power voltage ELVSS. In other example embodiments of the present invention, the time measuring unit 420 may measure the falling time TF of the low power voltage ELVSS or the rising time TR of the low power voltage ELVSS using a timer.

The power supply 430 may generate the red color high power voltage ELVDD_R, the green color high power voltage ELVDD_G, and the blue color high power voltage ELVDD_B for which overshoot times are controlled to be within the falling time during which the low power voltage is changed from the first level to the second level or to be within the rising time during which the low power voltage ELVSS is changed from the second level to the first level.

Referring to FIG. 4, the overshoot times of the red color high power voltage ELVDD_R, the green color high power voltage ELVDD_G, and the blue color high power voltage ELVDD_B may be controlled to be within the falling time of the low power voltage ELVSS or rising time of the low power voltage ELVSS. In some example embodiments of the present invention, when the pixels emit light while the low power voltage ELVSS has the second level, the power supply 430 may control the overshoot times of the red color high power voltage ELVDD_R, the green color high power voltage ELVDD_G, and the blue color high power voltage ELVDD_B to be within the falling time during which the low power voltage ELVSS is changed from the first level to the second level. Thus, the color abnormality defect caused by a difference in the degree of coupling of the red color high power voltage ELVDD_R, the degree of coupling of the green color high power voltage ELVDD_G, and the degree of coupling of the blue color high power voltage ELVDD_B may be improved.

In other example embodiments of the present invention, when the pixels emit light while the low power voltage ELVSS has the first level, the power supply 430 may control the overshoot time of the red color high power voltage ELVDD_R, the green color high power voltage ELVDD_G, and the blue color high power voltage ELVDD_B to be within the rising time during which the low power voltage ELVSS is changed from the second level to the first level. Thus, the color abnormality defect caused by a difference in the degree of coupling of the red color high power voltage ELVDD_R, the degree of coupling of the green color high power voltage ELVDD_G, and the degree of coupling of the blue color high power voltage ELVDD_B may be improved.

The power supply 430 may generate the red color high power voltage ELVDD_R for which the overshoot time is controlled according to the falling time TF of the low power voltage ELVSS or the rising time TR of the low power voltage ELVSS. The power supply 430 may generate the green color high power voltage ELVDD_G for which the overshoot time is controlled according to the falling time TF of the low power voltage ELVSS or the rising time TR of the low power voltage ELVSS. The power supply 430 may generate the blue color high power voltage ELVDD_B for which the overshoot time is controlled according to the falling time TF of the low power voltage ELVSS or the rising time TR of the low power voltage ELVSS.

The scan driver 440 may provide a scan signal to the pixels via the plurality of scan lines SLn. The data driver 450 may provide a data signal to the pixels via the plurality of data lines DLm according to the scan signal. The timing controller 460 may control the scan driver 440, the data driver 450, and the power supply 430 by generating a plurality of control signals CTL1 and CTL2.

As described above, the organic light emitting display device according to example embodiments of the present invention may measure the falling time TF of the low power voltage ELVSS or the rising time TR of the low power voltage ELVSS and may control the overshoot times of the red color high power voltage ELVDD_R, the green color high power voltage ELVDD_G, and the blue color high power voltage ELVDD_B to be within the falling time TF of the low power voltage ELVSS or the rising time TR of the low power voltage ELVSS. Thus, organic light emitting display device 400 may prevent or reduce the color abnormality defects caused by a difference in the degree of coupling of the red color high power voltage ELVDD_R, the degree of coupling of the green color high power voltage ELVDD_G, and the degree of coupling of the blue color high power voltage ELVDD_B.

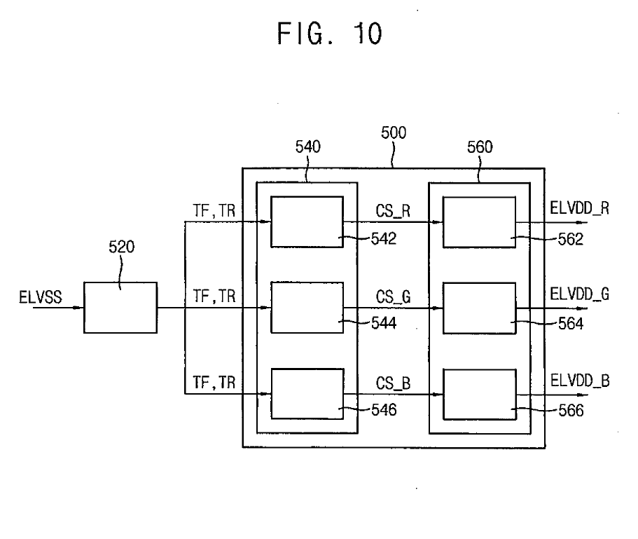

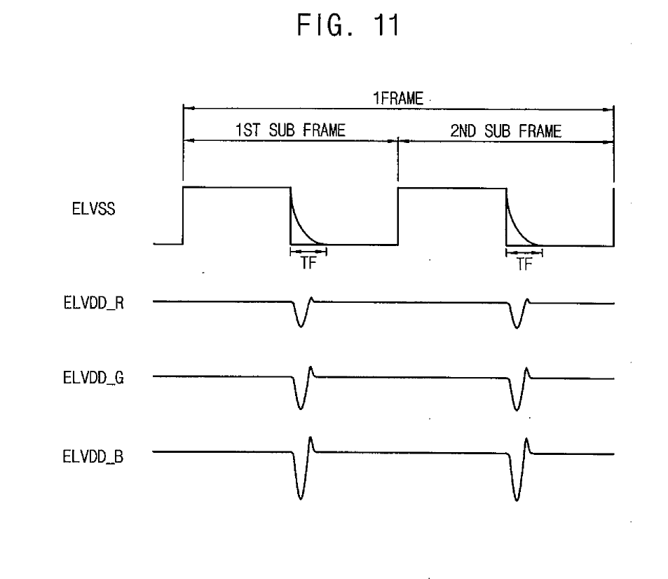

FIG. 10 is a block diagram illustrating a timing measuring unit and a power supply included in the organic light emitting display device of FIG. 8. The time measuring unit 520 of FIG. 10 may correspond to the time measuring unit 420 of FIG. 8, and the power supply 500 of FIG. 10 may correspond to the power supply 430 of FIG. 10.

Referring to FIG. 10, a time measuring unit 520 may measure a falling time TF during which a low power voltage ELVSS is changed from a first level to a second level or a rising time TR during which the low power voltage ELVSS is changed from the second level to the first level. In some example embodiments of the present invention, the time measuring unit 420 may include a clock generator that generates a reference clock CLK_R having a cycle (e.g., a predetermined cycle), may count the reference clock during the falling time TF of the low power voltage ELVSS or during the rising time TR of the low power voltage ELVSS, and may calculate the falling time TF or the rising time TR based on the counted reference clock CLK_R. The clock generator may generate the reference clock CLK_R having substantially the same width (e.g., having the same width) for each cycle. The time measuring unit 420 may calculate the falling time TF of the low power voltage ELVSS or the rising time TR of the low power voltage ELVSS based on the number of the reference clock CLK_R cycles during the falling time TF of the low power voltage ELVSS or the rising time TR of the low power voltage ELVSS. That is, the falling time TF of the low power voltage ELVSS or the rising time TR of the low power voltage ELVSS may be calculated by multiplying the number of the reference clock CLK_R cycles by the time during which the reference clock CLK_R is output.

In other example embodiments of the present invention, the time measuring unit 420 may include a timer and measure the falling time TF of the low power voltage ELVSS or the rising time TR of the low power voltage ELVSS. The falling time of the low power voltage ELVSS or the rising time TR of the low power voltage ELVSS that is measured in the time measuring unit 520 may be provided to the power supply 500.

The power supply may include a power voltage controller 540 and a power voltage generator 560.

The power voltage controller 540 may include a red color power voltage controller 542, a green color power voltage controller 544, and a blue color power voltage controller 546. The red color power voltage controller 542 may generate a red color power voltage control signal CS_R that controls the overshoot time of the red color high power voltage ELVDD_R according to the falling time TF of the low power voltage ELVSS or the rising time TR of the low power voltage ELVSS. The red color power voltage controller 542 may include a lookup table that stores the red color power voltage control signal CS_R corresponding to the falling time TF of the low power voltage ELVSS or the rising time TR of the low power voltage ELVSS. The red color power voltage control signal CS_R may control the overshoot time of the red color high power voltage ELVDD_R according to the falling time TF of the low power voltage ELVSS or the rising time TR of the low power voltage ELVSS. It should be understood that the lookup table can be implemented by any storage device capable of storing the red color power voltage control signal CS_R corresponding to the falling time TF of the low power voltage ELVSS or the rising time TR of the low power voltage ELVSS.

The green color power voltage controller 544 may generate a green color power voltage control signal CS_G that controls the overshoot time of the green color high power voltage ELVDD_G according to the falling time TF of the low power voltage ELVSS or the rising time TR of the low power voltage ELVSS. The green color power voltage controller 544 may include a lookup table that stores the green color power voltage control signal CS_G corresponding to the falling time TF of the low power voltage ELVSS or the rising time TR of the low power voltage ELVSS. It should be understood that the lookup table can be implemented by any storage device capable of storing the green color power voltage control signal CS_G corresponding to the falling time TF of the low power voltage ELVSS or the rising time TR of the low power voltage ELVSS.

The blue color power voltage controller 546 may generate a blue color power voltage control signal CS_B that controls the overshoot time of the blue color high power voltage ELVDD_B according to the falling time TF of the low power voltage ELVSS or the rising time TR of the low power voltage ELVSS. The blue color power voltage controller 546 may include a lookup table that stores the blue color power voltage control signal CS_B corresponding to the falling time TF of the low power voltage ELVSS or the rising time TR of the low power voltage ELVSS. It should be understood that the lookup table can be implemented by a storage device capable of storing the blue color power voltage control signal CS_B corresponding to the falling time TF of the low power voltage ELVSS or the rising time TR of the low power voltage ELVSS.

The power voltage generator 560 may include a red color power voltage generator 562, a green color power generator 564, and a blue color power generator 566. The red color power voltage generator 562 may generate the red color high power voltage ELVDD_R based on the red color power voltage control signal CS_R. The red color power voltage generator 562 of FIG. 10 may correspond to the red color power voltage generator 300 of FIG. 6. The red color power voltage generating 562 may change a resistance of the third resistor R3 based on the red color power voltage control signal CS_R. The red color power voltage generator 562 may generate the red color high power voltage ELVDD_R for which the overshoot time is controlled according to the resistance of the third resistor R3.

The green color power voltage generator 564 may generate the green color high power voltage ELVDD_G based on the green color power voltage control signal CS_G. The green color power voltage generator 564 of FIG. 10 may correspond to the green color power voltage generator 300 of FIG. 6. The green color power voltage generator 564 may change a resistance of the third resistor R3 based on the green color power voltage control signal CS_G. The green color power voltage generator 564 may generate the green color high power voltage ELVDD_G for which the overshoot time is controlled according to the resistance of the third resistor R3.

The blue color power voltage generator 566 may generate the blue color high power voltage ELVDD_B based on the blue color power voltage control signal CS_B. The blue color power voltage generator 566 of FIG. 10 may correspond to the blue color power voltage generator 300 of FIG. 6. The blue color power voltage generator 566 may change a resistance of the third resistor R3 based on the blue color power voltage control signal CS_B. The blue color power voltage generator 566 may generate the blue color high power voltage ELVDD_B for which the overshoot time is controlled according to the resistance of the third resistor R3.

As described above, the time measuring unit 520 according to example embodiments of the present invention may measure the falling time TF during which the low power voltage ELVSS is changed from the first level to the second level or the rising time TR during which the low power voltage ELVSS is changed from the second level to the first level. Further, the power supply 500 according to example embodiments of the present invention may generate the red color high power voltage ELVDD_R, the green color high power voltage ELVDD_G, and the blue color high power voltage ELVDD_B for which the overshoot times are controlled according to the falling time TF of the low power voltage ELVSS or the rising time TR of the low power voltage ELVSS. Thus, the color abnormality defect caused by a difference in degree of coupling of the red color high power voltage ELVDD_R, the green color high power voltage ELVDD_G, and the blue color high power voltage ELVDD_B may be improved.

FIG. 11 is a waveform diagram illustrating an example of the organic light emitting display device of FIG. 8 that is implemented as a 3D display device.

Referring to FIG. 11, when an organic light emitting display device operates as a 3D display device, left-eye image data and right-eye image data may be alternately provided to a display panel. One frame may include a first sub frame and a second sub frame. The left-eye image data may be provided to the display panel during the first sub frame, and the right-eye image data may be provided to the display panel during the second sub frame. The first sub frame may include an address period PA in which the left-eye image data is written into pixels and an emission period PE in which the pixels emit light based on the left-eye data. The low power voltage ELVSS may have the first level in the address period PA of the first sub frame, and may have the second level in the emission period PE of the first sub frame. The time measuring unit may measure the falling time TF during which the low power voltage ELVSS is changed from the first level to the second level.

The power supply may generate the red color high power voltage ELVDD_R, the green color high power voltage ELVDD_G, and the blue color high power voltage ELVDD_B of the first sub frame for which overshoot times are controlled to be within the falling time TF of the low power voltage ELVSS during which the low power voltage ELVSS is changed from the first level to the second level. Further, the second sub frame may include an address period PA in which the right-eye image data is written into pixels and an emission period PE in which the pixels emit light based on the right-eye image data. The low power voltage ELVSS may have the first level in the address period PA of the second sub frame, and may have the second level in the emission period PE of the second sub frame.

The power supply may generate the red color high power voltage ELVDD_R, the green color high power voltage ELVDD_G, and the blue color high power voltage ELVDD_B of the second sub frame for which overshoot times are controlled to be within the falling time TF of the low power voltage ELVSS during which the low power voltage ELVSS is changed from the first level to the second level. Thus, the color abnormality defect caused by a difference in a degree of coupling of the red color high power voltage ELVDD_R, a degree of coupling of the green color high power voltage ELVDD_G, and a degree of coupling of the blue color high power voltage ELVDD_B may be improved when the organic light emitting display device operates as the 3D display device.

Embodiments of the present invention may be applied to an electronic device having a display device. For example, embodiments of the present invention may be applied to a computer monitor, a laptop, a digital camera, a cellular phone, a smart phone, a smart pad, a television, a personal digital assistant (PDA), a portable multimedia player (PMP), a MP3 player, a navigation system, a game console, a video phone, etc.

The foregoing is illustrative of example embodiments of the present invention and is not to be construed as limiting thereof. Although a few example embodiments of the present invention have been described, those skilled in the art will readily appreciate that many modifications of the example embodiments are possible without materially departing from the novel teachings and aspects of the present invention. Accordingly, all such modifications are intended to be included within the scope of the present invention as defined in the claims and their equivalents. Therefore, it is to be understood that the foregoing is illustrative of various example embodiments of the present invention and is not to be construed as limited to the specific example embodiments of the present invention disclosed, and that modifications to the disclosed example embodiments, as well as other example embodiments, are intended to be included within the scope of the appended claims and their equivalents.

What is claimed is:

1. An organic light emitting display device comprising:
a display panel comprising:
a plurality of pixels;
a red color high power voltage line configured to provide a red color high power voltage to the pixels;
a green color high power voltage line configured to provide a green color high power voltage to the pixels;
a blue color high power voltage line configured to provide a blue color high power voltage to the pixels; and
a low power voltage line configured to provide a low power voltage to the pixels;
a driving current calculator configured to receive image data provided to the pixels and to respectively calculate an amount of a red color driving current of the image data, an amount of a green color driving current of the image data, and an amount of a blue color driving current of the image data;
a power supply configured to generate the red color high power voltage, the green color high power voltage, and the blue color high power voltage for which overshoot times are controlled to be within a falling time during which the low power voltage is changed from a first level to a second level or to be within a rising time during which the low power voltage is changed from the second level to the first level;
a data driver configured to provide a data signal to the pixels;
a scan driver configured to provide a scan signal to the pixels; and
a timing controller configured to control the power supply, the data driver, and the scan driver.

2. The device of claim 1, wherein the red color high power voltage line, the green color high power voltage line, and the blue color high power voltage line have a mesh structure.

3. The device of claim 1, wherein the power supply comprises:
a red color power voltage controller configured to calculate a degree of coupling of the red color high power voltage based on the amount of the red color driving current and to generate a red color power voltage control signal that controls the overshoot time of the red color high power voltage according to the degree of coupling of the red color high power voltage;
a green color power voltage controller configured to calculate a degree of coupling of the green color high power voltage based on the amount of the green color driving current and to generate a green color power voltage control signal that controls the overshoot time of the green color high power voltage according to the degree of coupling of the green color high power voltage;
a blue color power voltage controller configured to calculate a degree of coupling of the blue color high power voltage based on the amount of the blue color driving current and to generate a blue color power voltage control signal that controls the overshoot time of the blue color high power voltage according to the degree of coupling of the blue color high power voltage;
a red color power voltage generator configured to generate the red color high power voltage based on the red color power voltage control signal;
a green color power voltage generator configured to generate the green color high power voltage based on the green color power voltage control signal;
a blue color power voltage generator configured to generate the blue color high power voltage based on the blue color power voltage control signal; and
a low power voltage generator configured to generate the low power voltage.

4. The device of claim 3, wherein each of the red color power voltage generator, the green color power voltage generator, and the blue color power voltage generator comprises:
a first resistor;
a second resistor, wherein the first resistor and the second resistor are configured to generate a divided voltage by dividing an output voltage provided to the display panel;
a differential amplifier configured to output a difference between the divided voltage and a reference voltage;
a third resistor;
a first capacitor, wherein the third resistor and the first capacitor are configured to control an output time of the differential amplifier;
a comparator configured to compare an output of the differential amplifier with a sawtooth wave; and
a half-bridge block configured to output a pulse width modulation (PWM) signal based on an output of the comparator.

5. The device of claim 4, wherein third resistor is implemented as a digital variable resistor.

6. The device of claim 5, wherein a resistance of the third resistor is changed based on the red color power voltage control signal, the green color power voltage control signal, and the blue color power voltage control signal, respectively.

7. The device of claim 1, wherein the driving current calculator comprises:
a red color driving current calculator configured to calculate the amount of the red color driving current of the image data;
a green color driving current calculator configured to calculate the amount of the green color driving current of the image data; and
a blue color driving current calculator configured to calculate the amount of the blue color driving current of the image data.

8. The device of claim 1, wherein the driving current calculator is in the timing controller or is coupled to the timing controller.

9. The device of claim 1, wherein the image data comprises left-eye image data and right-eye image data when the organic light emitting display device operates as a 3D display device.

10. The device of claim 9, wherein the low power voltage has the first level during an address period in which the left-eye image data or the right-eye image data are written into the pixels, and
wherein the low power voltage has the second level during an emission period in which the pixels emit light based on the left-eye image data or the right-eye image data.

11. An organic light emitting display device comprising:
a display panel comprising:
a plurality of pixels;
a red color high power voltage line configured to provide a red color high power voltage to the pixels;
a green color high power voltage line configured to provide a green color high power voltage to the pixels;
a blue color high power voltage line configured to provide a blue color high power voltage to the pixels; and
a low power voltage line configured to provide a low power voltage to the pixels;
a time measuring unit configured to measure a falling time during which the low power voltage is changed from a first level to a second level or a rising time during which the low power voltage is changed from the second level to the first level;
a power supply configured to generate the red color high power voltage, the green color high power voltage, and the blue color high power voltage for which overshoot times are controlled to be within the falling time of the low power voltage or to be within the rising time of the low power voltage;
a data driver configured to provide a data signal to the pixels;
a scan driver configured to provide a scan signal to the pixels; and
a timing controller configured to control the power supply, the data driver, and the scan driver.

12. The device of claim 11, wherein the red color high power voltage line, the green color high power voltage line, and the blue color high power voltage line have a mesh structure.

13. The device of claim 11, wherein the power supply comprises:
a red color power voltage controller configured to generate a red color power voltage control signal that controls the overshoot time of the red color high power voltage according to the falling time of the low power voltage or the rising time of the low power voltage;
a green color power voltage controller configured to generate a green color power voltage control signal that controls the overshoot time of the green color high power voltage according to the falling time of the low power voltage or the rising time of the low power voltage;
a blue color power voltage controller configured to generate a blue color power voltage control signal that controls the overshoot time of the blue color high power voltage according to the falling time of the low power voltage or the rising time of the low power voltage;
a red color power voltage generator configured to generate the red color high power voltage based on the red color power voltage control signal;
a green color power voltage generator configured to generate the green color high power voltage based on the green color power voltage control signal;
a blue color power voltage generator configured to generate the blue color high power voltage based on the blue color power voltage control signal; and
a low power voltage generator configured to generate the low power voltage.

14. The device of claim 13, wherein each of the red color power voltage generator, the green color power voltage generator, and the blue color power voltage generator comprises:
a first resistor;
a second resistor, wherein the first resistor and the second resistor are configured to generate a divided voltage by dividing an output voltage provided to the display panel;
a differential amplifier configured to output a difference between the divided voltage and a reference voltage;
a third resistor;
a first capacitor, wherein the third resistor and the first capacitor are configured to control an output time of the differential amplifier;
a comparator configured to compare an output of the differential amplifier with a sawtooth wave; and
a half-bridge block configured to output a pulse width modulation (PWM) signal based on the output of the comparator.

15. The device of claim 14, wherein the third resistor is implemented as a digital variable resistor.

16. The device of claim 15, wherein a resistance of the third resistor is changed based on the red color power voltage control signal, the green color power voltage control signal, and the blue color power voltage control signal, respectively.

17. The device of claim 11, wherein the time measuring unit comprises a clock generator configured to generate a reference clock having a cycle, and
wherein the time measuring unit counts the reference clock during the falling time of the low power voltage or during the rising time of the low power voltage, and calculates the falling time of the low power voltage or the rising time of the low power voltage based on the counted reference clock.

18. The device of claim 11, wherein the time measuring unit measures the falling time of the low power voltage or the rising time of the low power voltage using a timer.

19. The device of claim 11,
wherein image data is provided to the pixels, and
wherein the image data comprises left-eye image data and right-eye image data when the organic light emitting display device operates as a 3D display device.

20. The device of claim 19, wherein the low power voltage has the first level during an address period in which the left-eye image data or the right-eye image data are written into the pixels, and
wherein the low power voltage has the second level during an emission period in which the pixels emit light based on the left-eye image data or the right-eye image data.
